(19) United States
(12) Patent Application Publication
(10) Pub. No.: US 2025/0103877 A1
(43) Pub. Date: Mar. 27, 2025

(54) UNLEARNING IN PRE-TRAINED GENERATIVE MACHINE LEARNING MODELS

(71) Applicant: Amazon Technologies, Inc., Seattle, WA (US)

(72) Inventors: Sujitha Catherine MARTIN, San Jose, CA (US); Yash Jayesh SHAH, Sunnyvale, CA (US); Emmett Daniel GOODMAN, San Francisco, CA (US); Negin SOKHANDAN ASL, Santa Clara, CA (US)

(21) Appl. No.: 18/474,062

(22) Filed: Sep. 25, 2023

(51) Int. Cl. G06N 3/08; G06N 3/0475

(52) U.S. Cl. CPC G06N 3/08; G06N 3/0475

(57) ABSTRACT

Techniques for unlearning concepts in the use of a pre-trained generative machine learning model are described. A description of a concept to be unlearned in use of a pre-trained generative machine learning model is received. Negative prompts and positive prompts are processed with the pre-trained generative machine learning model to generate associated activation volume maps. A set of conditions to differentiate activation volume maps associated with negative prompts from activation volume maps associated with positive prompts is identified. A model adapter is generated, the model adapter to use a set of different model parameters when processing of a prompt by the pre-trained generative machine learning model satisfies the set of conditions.

### BACKGROUND

Recent advancements in machine learning have given rise to large pre-trained generative models (sometimes called foundation models). These pre-trained models can serve as a starting point for task-specific customization. Initially trained on vast amounts of data using significant computing resources over hours, days, weeks, or even months, such pre-trained models have demonstrated remarkably levels of performance. By fine-tuning these models, users are able to tailor the model outputs to a given application at a fraction of the up-front training cost.

### BRIEF DESCRIPTION OF DRAWINGS

Various examples in accordance with the present disclosure will be described with reference to the following drawings.

FIG. 1 is a diagram illustrating an example environment for a model unlearning training service according to some examples.

FIG. 2 is a diagram illustrating an example model architecture including a model adapter according to some examples.

FIG. 3 is a diagram illustrating an example graphical user interface to a model unlearning training service according to some examples.

FIG. 4 is a diagram illustrating exemplary training dataset generation according to some examples.

FIG. 5 is a diagram illustrating exemplary adapter detector fitting according to some examples.

FIGS. 6A, 6B, and 6C are diagrams illustrating exemplary model parameter update strategies according to some examples.

FIG. 7 is a flow diagram illustrating operations of a method for generating a pre-trained generative model adapter according to some examples.

FIG. 8 illustrates an example cloud provider network environment according to some examples.

FIG. 9 is a block diagram of an example cloud provider network that provides a storage service and a hardware virtualization service to customers according to some examples.

FIG. 10 is a block diagram illustrating an example computing device that can be used in some examples.

### DETAILED DESCRIPTION

The present disclosure relates to methods, apparatus, systems, and non-transitory computer-readable storage media for unlearning in pre-trained generative machine learning models. According to some examples, a model unlearning training service of a cloud provider network generates an adapter that modifies the behavior of a pre-trained generative model during inference operations such that the pre-trained model “forgets” or “unlearns” how to generate outputs including a particular concept. More specifically, the adapter can include a detector that operates to enable or disable the application of updated model parameters that, when applied, perturb the model away from generating outputs that include an “unlearned” concept. As used herein, “unlearning,” also referred to as “intentional forgetting,” refers to modifying the parameters of a pre-trained generative AI model in a manner that biases it away from generating a concept during inference operations.

Generative AI systems are typically used to create new content in various modalities (e.g., text, images, audio, videos) given input from users in one or more of those modalities. Generative AI systems often rely on neural network technology. Neural networks are a powerful tool for modeling complex patterns and relationships in data. A “neuron” in a neural network is a basic computational unit. Such a neuron typically includes an input (from one or more outputs of a previous layer of the network), weights representing the strength of connections of those inputs, a bias that can provide an offset to the weighted sum of the inputs, and an activation function that generates an output, the activation function introduces a non-linearity between the inputs and the output (e.g., if the biased weighted sum is less than zero, the output is zero, otherwise, the output is the biased weighted sum).

A pre-trained generative AI model generally consists of a model definition that specify how the neural network is constructed and model parameters that specify the parameters of the network (e.g., weights, biases, and other parameters) learned during training that cause the model to perform a useful function at inference time—e.g., prompting a generative image model to generate a picture of a house results in a picture of a house rather than something else. Some generative AI systems employ in-built content moderation modules to block or filter inappropriate or objectionable content after it has already been generated. However, such functionalities are often generic (e.g., not-safe-for-work content moderation) and do not address individual users' needs and definitions of content moderation.

As detailed herein, unlearning causes a previously-trained neural network to forget a previously learned concept by modifying how the model operates during the processing of a prompt to generate an output response. “Concept” here refers to the modality-specific object(s) that the pre-trained model was previously capable of generating. For example, in language generation, a concept may be a name, place, word, phrase, slang, etc., in image or video generation a concept may be an object, a class of objects, styles, branding, trademarks, etc., or in audio generation a concept may be a melody, an instrument, a voice, a music genre, etc. Note that a concept may represent multiple things, such as a class of objects, set of words, set of voices, etc.

The model unlearning training service allows users to easily achieve custom content moderation in their generative AI systems. At a high level, users can identify a concept to be forgotten by, for example, providing a text description, selecting from a list of various topics or keywords, or providing labeled samples of the output with or without the concept. In some examples, the service allows users to customize the degree to which the concept is forgotten. Based on the concept identification, the service can generate or expand a sample dataset to exercise the model in a variety of ways. The sample dataset can include inputs that cause the model to generate outputs that include the unwanted concept, do not include the unwanted concept, or include similar or adjacent concepts to the unwanted concept. The service then exercises the model with the sample dataset, capturing the model behavior (e.g., neuron activations) as it processes the samples. The service can use the captured data to identify a pattern or “fingerprint” of the model that is statistically indicative of when the model will generate the concept to be forgotten. Using that pattern, the service can define the detector that selectively apply model parameter updates. Applying the parameter updates steers the remaining forward pass operations through the model away from the concept. The updated model parameters can be set or calculated. For example, the weights of the activations to the downstream model layer(s) may be set to zero, or adjusted to fuzz the activations (e.g., to scale them based on a noise function), or computed to bias the model toward another related concept. The service enables users to customize pre-trained generative models at a fraction of the computational time and cost would otherwise be required if they were to attempt to re-train the model using a dataset that excluded or used negative reinforcement on the concept to be forgotten.

The techniques described herein have a wide variety of use cases. For example, an advertiser customizing a generative image model may want to eliminate logos of various companies in a competitive space. Such logos may inadvertently appear in outputs of a baseline pre-trained generative AI model by virtue of those companies having their products represented in the training data used to initially train the pre-trained model. As another example, a medical school may want to generate anatomically accurate pictures of a heart rather than emojis or emoticons that may have been learned by the pre-trained model. Note that “negative prompting” is a technique that can be used to bias a generative model away from an undesired output. For example, the prompt “generate a picture of a heart and not a heart emoji” could be considered a negative prompt. The responsibility of avoiding a concept with negative prompting thus falls on the end-user, which can be undesirable for individuals or organizations deploying a model to a wider audience.

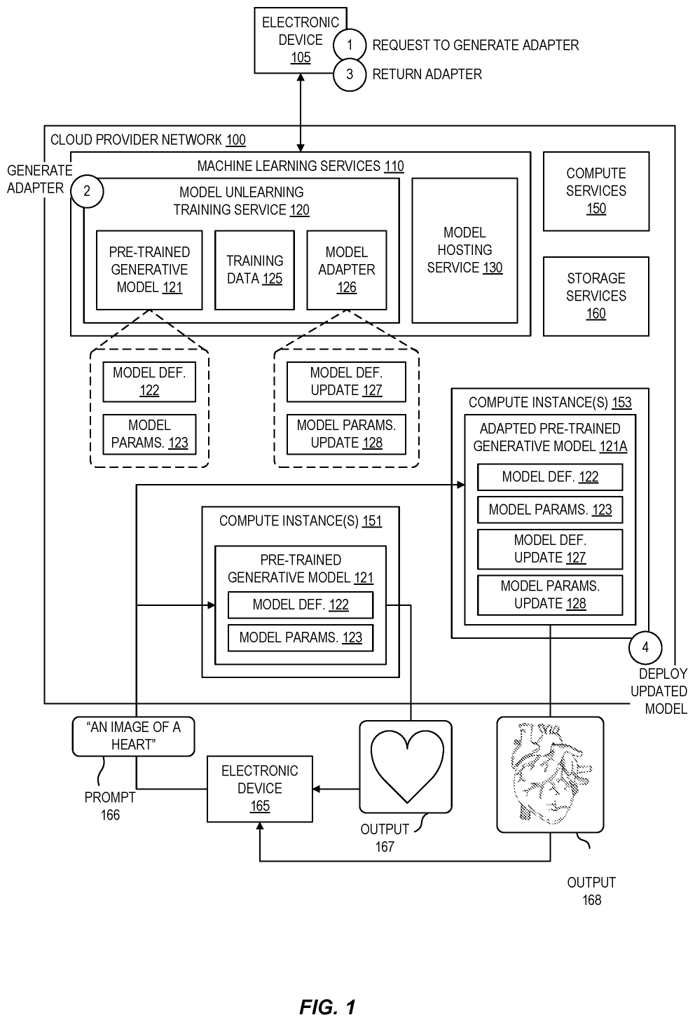

FIG. 1 is a diagram illustrating an example environment for a model unlearning training service according to some examples. In this example, a model unlearning training service 120 is offered as part of machine learning services 110 of a cloud provider network. Machine learning services 110 can be implemented as hardware, software applications (e.g., computer programs), or a combination of both with computing resources of the cloud provider network 100. Other machine learning services can include, for example, a model hosting service 130 and a model training service (not shown). Such model training and hosting services allow users or customers of the cloud provider network to train and host machine learning models using resources of the cloud provider network.

A cloud provider network 100 (also referred to herein as a provider network, service provider network, etc.) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as compute services 150 that can execute compute instances (e.g., virtual machines, containers, etc.), storage services 160 that can provide object- or block-level data storage, databases, etc. The users (or “customers”) of cloud provider networks 100 can use one or more user accounts that are associated with a customer account, though these terms can be used somewhat interchangeably depending upon the context of use. Cloud provider networks are sometimes “multi-tenant” as they can provide services to multiple different customers using the same physical computing infrastructure.

Users can interact with a cloud provider network 100 across one or more intermediate networks (e.g., the internet) via one or more interface(s), such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the cloud provider network 100 that includes “backend” services supporting and enabling the services that can be more directly offered to customers.

Thus, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

To provide these and other computing resource services, cloud provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network may provide may be referred to as a “managed compute service” that executes code or provides computing resources for its users in a managed configuration. Examples of managed compute services include, for example, a hardware virtualization service, an on-demand code execution service, a container service, or the like. Such services can be provided as compute services 150. A hardware virtualization service (referred to in various implementations as an elastic compute service, a virtual machines service, a computing cloud service, a compute engine, or a cloud compute service) can enable users of the cloud provider network 100 to provision and manage compute resources such as virtual machine instances.

As described herein, the model unlearning training service 120 allows users to leverage pre-trained generative AI/machine learning models (or, for short, a pre-trained generative model) while providing those users with additional controls over the generated outputs. In particular, the model unlearning training service 120 produces adapters to cause pre-trained generative models to “forget” or “unlearn” concepts identified by a user. Such adapters enable finer control over model outputs with relatively low computational overhead as compared to other fine-tuning techniques or re-training a generative model without data including or with negative reinforcement of the unwanted concept.

In FIG. 1, the circles labeled (1)-(4) illustrate an example process in which a user leverages the model unlearning training service 120 to customize a pre-trained generative model by unlearning a concept.

As shown at circle (1), a user (not shown) operating an electronic device 105 executing a software application such as a web-browser, standalone application, integrated development environment (IDE), or the like, interacts with the machine learning services 110. In particular, the electronic device 105 can send a request to the model unlearning training service 120 to initiate the creation of an adapter that can cause a pre-trained generative model to forget or unlearn a concept.

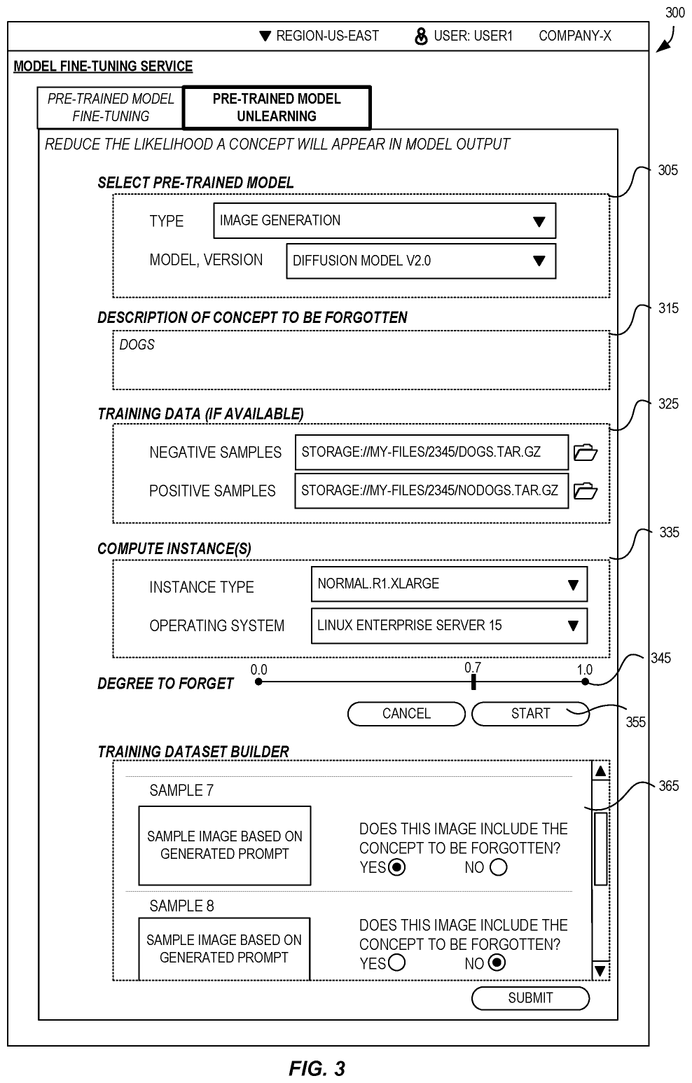

In some examples, the software application can provide an interface (e.g., a web-based interface) for use by a user to invoke the creation of an adapter. For example, FIG. 3 is a diagram illustrating an example graphical user interface to a model unlearning training service according to some examples. The illustrated graphical user interface (GUI) 300 can be provided by a frontend to the machine learning services 110 of the cloud provider network 100, e.g., via a console type application offered via a browser or a standalone application.

The GUI 300 includes several input fields allowing a user to invoke the model unlearning training service 120. The GUI 300 includes fields 305 to provide for the selection of the base pre-trained generative model. Here, the GUI 300 includes a drop-down menu from which a class of models can be selected (e.g., image generation, language generation, etc.) and a dependent drop-down menu from which available models within that class can be selected.

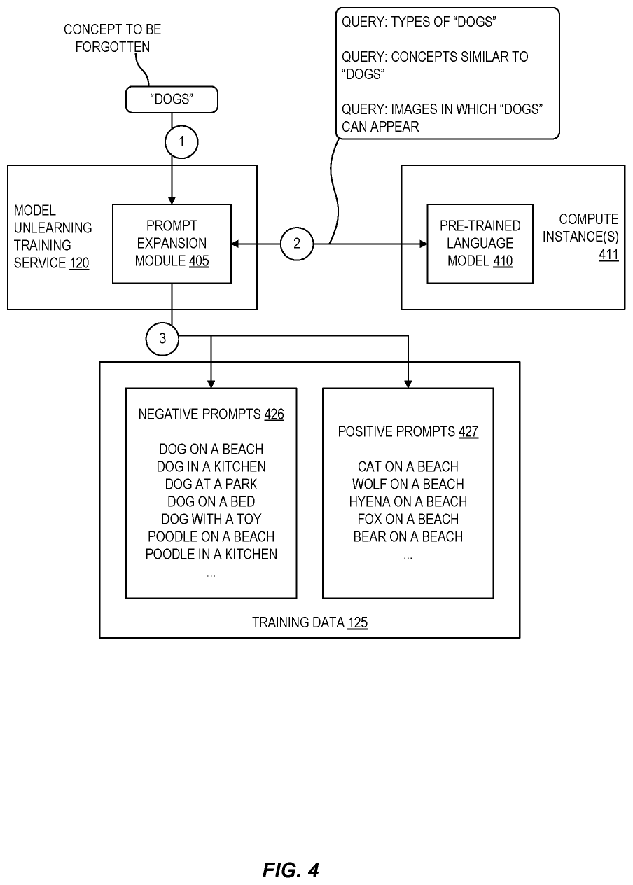

The GUI 300 includes a text entry field 315 in which a user can provide a textual description of the concept to be forgotten. Here, and continued in the training dataset generation of FIG. 4, the user has identified “dogs” as the concept to be unlearned. In other examples, a GUI may provide a list of topics or keywords from which a user can select the concept to be forgotten.

The GUI 300 includes fields 325 in which a user can identify existing training data, if available. In the image modality, existing training data can be images with labels. Here, the user can provide negative samples (e.g., samples that include the concept to be forgotten) and positive samples (e.g., samples that do not include the concept to be forgotten).

The GUI 300 includes fields 335 in which a user can specify the compute resources to use during unlearning, for example a virtual machine executed by underlying host systems without or with (particular hardware acceleration), etc.

The GUI 300 includes a selector 345 in which a user can specify the degree to which the model unlearning training service 120 should attempt to modify the pre-trained generative model to unlearn the concept. Since neural network-based models are largely probabilistic, the model unlearning training service 120 can provide such a selection as different degrees of censure can affect the model's performance with respect to other adjacent concepts.

The GUI 300 includes a button 355 to allow a user to initiate the creation of an adapter by the model unlearning training service 120. Note that the electronic device displaying the GUI 300 can assemble the inputs specified by the GUI and send them in one or more messages to the model unlearning training service 120 to indicate a request.

In some examples, a GUI can provide for user provided feedback during the development of a training dataset used for the fitting of a model adapter to a concept. Here, the GUI 300 includes a box 365 in the lower part identified as a “training dataset builder.” The model unlearning training service 120 can return representative samples based on prompts developed to expand the concept to be forgotten, soliciting user feedback on whether the prompt-generated images include the concept to be forgotten. In some examples, the model unlearning training service 120 can leverage a visual-language model such as CLIP to provide more targeted questions. For example, using CLIP, the model unlearning training service 120 can identify a set of objects in an image and provide the user with the option to select one or more of the objects as the concept to be forgotten. In either case, the user can submit the feedback, which the model unlearning training service 120 can use to categorize certain prompts as either negative or positive. In some examples, the feedback can be performed using a visual prompting rather than the “yes/no” selectors as illustrated. The GUI can display a prompt-generated image and allow the users to select regions of the image that include the concept to be forgotten. For example, the model unlearning training service 120 can pre-identify objects in an image (e.g., using CLIP) that are then selectable by the user. As another example, the user may be able to select a region of the image, and the model unlearning training service 120 can then identify the object within the selected region (e.g., using CLIP) to determine the concept to be forgotten.

Turning back to FIG. 1, the model unlearning training service 120 includes a pre-trained generative model 121, training data 125, and a model adapter 126. The model 121 may be one of many other models offered via machine learning services 110. Similarly, the adapter 126 may be one of many other adapters generated for the same model 121, for other models, for other concepts with the same model 121, or for the same or other concepts with other models, etc., and the training data 125 may be one set of many training datasets. Models, training datasets, and adapters can be stored using storage services 160.

In some examples, a pre-trained generative model such as model 121 includes a model definition 122 and model parameters 123. An exemplary pre-trained model definition 122 may be specified in human (e.g., Python) or machine readable code (e.g., compiled code) that specifies the flow of data through the model. For example, an image generation model may include a frontend encoder to encode a text-based prompt into an embedding space to feed a diffusion model is fed to generate an output. The model definition 122 can reference the pre-trained parameters, which were learned during the prior training process (often over the course of days, weeks, months, etc.).

The lower portion of FIG. 1 illustrates the different behavior of a pre-trained generative model with and without a trained adapter using the earlier example of generating an anatomically accurate images of a heart. Initially, the pre-trained generative model 121, including model definition 122 and model parameters 123, is executed by one or more compute instances 151. A user (which may be the user submitting the earlier adapter creation request or another user) can submit a prompt 166 to the model 121. Assuming the model 121 was trained on a sufficiently diverse dataset (e.g., harvested from the internet), the model may tend toward cartoonish images of hearts, resulting in the output 167 absent further prompt refinement.

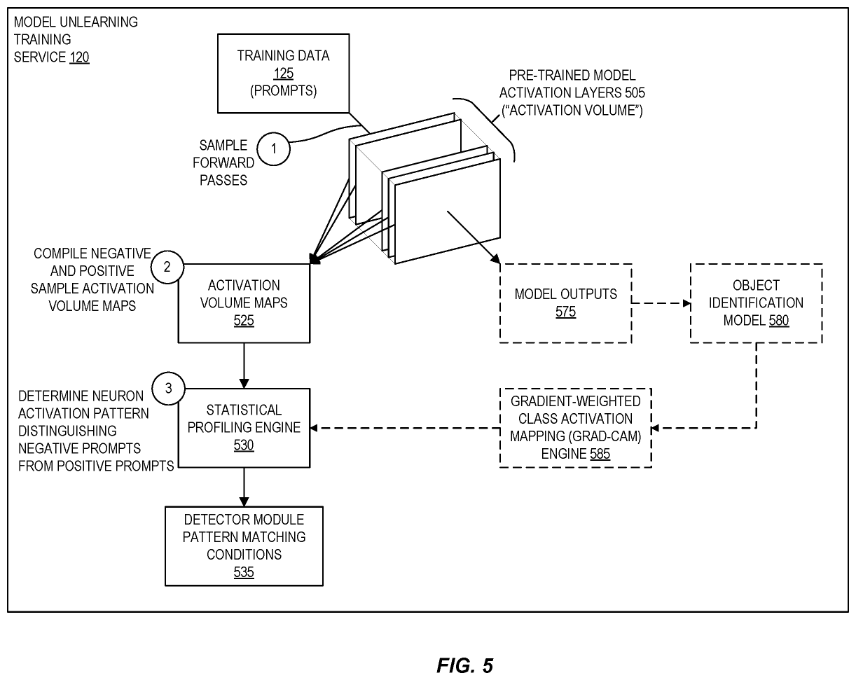

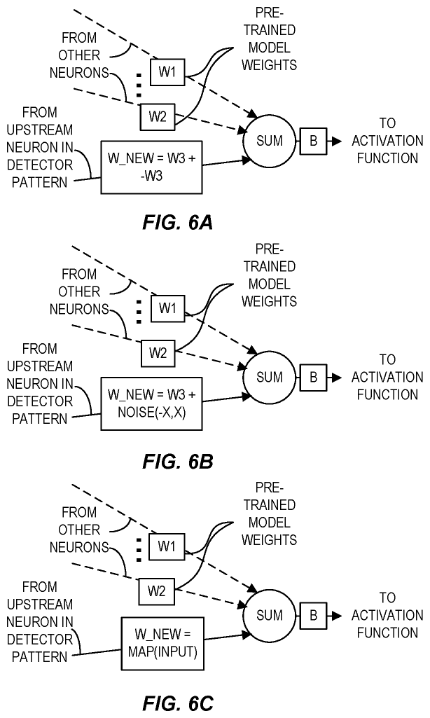

Upon receipt of a request to generate an adapter, the model unlearning training service 120 generates a model adapter, as indicated at circle (2). Briefly, generating the adapter components includes building or expanding a training dataset (if insufficient samples, if any, were provided in the request), fitting a detector to the identified concept to be forgotten, and generating parameters updates to apply to the pre-trained model parameters (typically weight updates to apply to the pre-trained weights). The parameter updates can then be applied during inference (e.g., summed to existing pre-trained model parameters) or used to generate a separate set of model parameters that are used to adjust the inference data flow through separate layers or neurons. Additional details on dataset generation are provided with reference to FIG. 4. Additional details on detector fitting are provided with reference to FIG. 5. Additional details on parameter update generation are provided with reference to FIG. 6.

In some examples, a model adapter such as model adapter 126 includes a model definition update 127 and model parameter updates 128. The model definition update 127 can represent changes to the model definition 122 to include the detector operations and resulting conditional weight updates and may be provided as one or more lines of code that can be incorporated in the definition 122. The model definition update 127 can reference the parameters 123 and the update parameters 128, conditionally combining the parameters 123 with the update parameters 128 upon a detection of the concept to be unlearned. The parameters 123 can thus remain unchanged for subsequent prompt processing.

In some examples, a model adapter such as model adapter 126 includes a model definition update 127 and precomputed model parameters for an alternate data flow to that of the original model definition. The precomputed model parameters can be a set of parameters calculated based on the original pre-trained model parameters. Upon detection of the concept to be unlearned, the model definition update 127 can cause an intermediate output of the pre-trained model to use the precomputed model parameters rather than the original pre-trained model parameters, effectively bypassing certain neurons or layers of the pre-trained model and routing the data processing through alterative (or parallel) neurons or layers of the model adapter, with the output of those neurons or layers then routed back into the downstream neurons or layers of the pre-trained model. Whether dynamically updating pre-trained model parameters or rerouting data processing through alternate neurons/layers with different parameters, a model adapter causes at least a portion of the processing of a prompt to use a different set of parameters than those of the pre-trained model.

In some examples, once the model unlearning training service 120 generates an adapter, it can return the adapter to the requestor, in this case the electronic device 105 as indicated at circle (3). Providing the adapter can allow the user initiating the request to deploy the model with adapter in other environments.

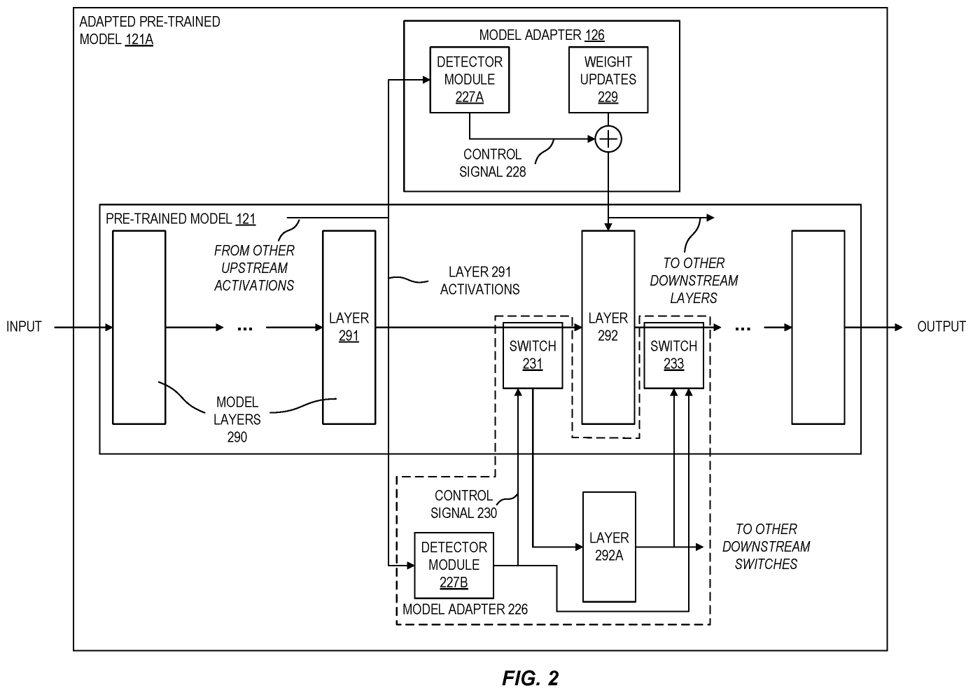

In some examples, the machine learning services 110 can receive a request (not shown) to host the adapted pre-trained model via model hosting service 130. An adapted pre-trained model refers to a pre-trained model including an adapter generated to unlearn a concept. As illustrated at circle (4), an adapted pre-trained generative model 121A is executed by one or more compute instance(s) 153. In this example, the adapted model 121A includes the model definition 122, model parameters 123, model definition update 123, and model parameters update 128. Note that in practice, the model definition update 123 can be applied to the model definition 122 resulting in a combined model definition that differs from that of the original pre-trained model. Now, assuming the model unlearning training service 120 generated an adapter to unlearn cartoonish hearts, when the user submits the prompt 166 to the adapted model 121A, the model can output an image 168 of a reasonable anatomical approximation of a heart without further prompt refinement. Additional details on an exemplary architecture of an adapted pre-trained model are illustrated and described with reference to FIG. 2.

Note that while the operations for generating a model adapter are illustrated and described with respect to the service 120, they can be performed in other non-cloud or non-service environments.

Further note that while unlearning is illustrated here and in subsequent figures in the context of text to image generation, unlearning can be extended readily to generation of other type of modalities (e.g., text, audio, etc.).

FIG. 2 is a diagram illustrating an example model architecture including a model adapter according to some examples. As illustrated, the pre-trained model 121 includes multiple layers 290, including layers 291 and 292. During inference, an input, such as a text prompt, is received and processed by the model to generate an output, such as an image. When processing an input, outputs from an upstream layer are passed to one or more “downstream” layers (feedback loops, recursive mechanisms, or other non-linearities may exist, not shown). An adapter includes a detector module that monitors the outputs (typically activations) of one or more layers and, based on those values, controls the use of different weights (or, more generally, parameters) in the continued forward pass processing of the prompt.

In the illustrated example adapter 126, the model adapter 126 monitors the activations from layer 291 via detector module 227A. When the pattern or “fingerprint” of a concept to be forgotten appears in the monitored activations, the detector module 227A activates a control signal 228 to cause continued forward pass processing of the input to use the different parameters and thereby perturb the downstream data flow away from the concept. A detector can leverage various techniques to perform detections. For example, a detector can evaluate a set of Boolean conditions to determine whether the activation levels of a set of neurons being monitored match a pattern associated with the concept to be forgotten (e.g., neuron A above a level, neuron B below a level, and so on).

Note that the different parameters can be employed to affect forward pass processing in a number of ways. With example adapter 126, the control signal 228 causes the summation of weight updates 229 to pre-trained weights of layer 292. When detector does not detect the pattern, the control signal 228 remains inactive, and the model 121 processes the prompt normally (e.g., without the application of the parameter updates).

In other examples, the parameter updates may be a different set of parameters such that instead of adding the parameter updates to original parameters of the pre-trained model and processing the upstream output with the same layer, a control signal causes outputs from one layer to be rerouted through parallel paths (e.g., neurons, layers, etc.) that have the alternative model parameters, thereby bypassing the default model paths with the original pre-trained parameters. This is illustrated by the dashed example model adapter 226. The model adapter 226 monitors the activations from layer 291 via detector module 227B. As before, when the pattern or of a concept to be forgotten appears in the monitored activations, the detector module 227B activates a control signal 228 to cause continued forward pass processing to switch through layer 292A via switches 231, 233. Layer 292A includes different parameters than layer 292, resulting in the perturbation of the downstream data flow away from the concept.

Although the above examples use layers and weights, other examples can use different parameters (e.g., biases, parameterized activation functions, etc.) or granularities (e.g., individual neurons instead of layers) to perturb the model away from the concept to be forgotten.

In some examples, the detector module 227 can monitor activations from multiple layers as indicated (e.g., from layer 291 and one or more adjacent or nonadjacent upstream layers). Likewise, the weight updates 229 (or bypasses) may be applied to multiple layers as indicated (e.g., to the pre-trained weights of layer 292 and one or more adjacent or nonadjacent downstream layers). In some examples, one or more other layers may reside between the activation(s) of layer(s) being monitored by the detector module 227 and the use of different weights in the downstream layer(s).

Note that multiple adapters can be applied to one model for the same or different concepts to be forgotten. In some examples, a layered approach may be taken for a single concept, where a first detector observes activations earlier in the model than a second detector, either having the ability to inject weight updates to a downstream layer should they detect a representation of the concept to be forgotten during inference. In some examples, multiple adapters can be generated for different concepts and applied to the same model.

FIG. 4 is a diagram illustrating exemplary training dataset generation according to some examples. The model unlearning training service 120 includes a prompt expansion module 450 to generate a set of prompts to process with a pre-trained generative model that can later be used to identify a pattern representing a concept to be forgotten. In FIG. 4, the circles labeled (1)-(3) illustrate an example process in which a training dataset is generated. Note that the illustrated example relates to generating a training dataset for text-to-image generative models. Other types of models can include different mode prompts and outputs (e.g., images, audio samples, etc.). The development of a training dataset as described herein can be adjusted for these other modalities.

At circle (1), the model unlearning training service 120 receives an indication of the concept to be forgotten (in this example the textual description, “dogs”). At circle (2), the prompt expansion module 450 leverages another pre-trained language model 510 executed by one or more compute instances 411. The pre-trained language model 510, which may be a large language model (LLM), can model semantic relationships between words. Querying the model 510, the prompt expansion module 450 can identify additional dimensions across which to develop a set of prompts. For example, the prompt expansion module 450 can query the model 510 for variables such as other objects that look like the identified concept or settings in which the identified concept may be illustrated. Such queries may be pre-defined for the modality (e.g., related concepts, scenes, views, etc.). The prompt expansion module 450 can classify the prompts as negative prompts 426 or positive prompts 427 (under the convention used herein, negative refers to samples that include or are likely to cause an output of a concept to be forgotten). For example, the prompt expansion module 450 can classify the prompts based on whether they include the concept to be forgotten, classifying prompts that reference dogs or species of dogs as negative prompts 426.

In some examples, the model 510 may return an indication of the strength of the relationship between the query and returned results. The prompt expansion module 450 can use the threshold to determine whether to classify the resulting prompts as positive or negative. For example, the model may return values indicating that a dog and a wolf have a higher correlation than a dog and a cat. The model unlearning training service 120 can classify prompts having a low correlation (e.g., below a threshold) as positive prompts and high correlation (e.g., above the threshold) as negative prompts.

Although not shown, training dataset generation can include the model unlearning training service 120 prompting the pre-trained generative model with sample prompts resulting from the prompt expansion. The model unlearning training service 120 can then provide the generated outputs to a user (e.g., via box 365 of GUI 300) to solicit the user's feedback on whether the prompts resulted in images that include or do not include the concept to be forgotten. Based on the user's feedback, the model unlearning training service 120 can classify the prompts associated with the presented images into their corresponding negative or positive sample groups 426, 427.

In some examples, the model unlearning training service 120 can select prompts for which to solicit user feedback based on prompts from model 510 responses having a very strong relationship with the concept (e.g., above a second, higher threshold). Continuing the previous example, the model unlearning training service 120 could obtained imagery generated from such prompts to further refine the user's request (e.g., prompt the user with an image generated using a wolf-based prompt and not a cat-based prompt based on the former correlation exceeding a threshold and the latter not).

FIG. 5 is a diagram illustrating exemplary adapter detector fitting according to some examples. The detector operates to predict, during prompt processing by a pre-trained generative model, whether the ultimate model output will include the concept to be unlearned. If so, the detector causes the adapter to perturb model weights to reduce the likelihood of the concept appearing in the output. To identify the set of conditions that identify a concept to be forgotten during intermediate processing stages by the model (and thus when to perturb or apply the update weights), the model unlearning training service 120 relies on statistical techniques to extract the pattern or fingerprint of the concept based on positive and negative samples.

In FIG. 5, the circles labeled (1)-(3) illustrate an example process in which a detector conditions are identified. Machine learning models typically can be represented as an activation volume, conceptually illustrated by activation layers 505. Different inputs can yield different activation volume maps. As used herein, activation volume maps refer to all or a portion of a model's activation volume captured during the processing of an input prompt. The activation volume includes values output from one or more layers of the neural network.

At circle (1), the model unlearning training service 120 processes the training data 125—the negative and positive prompts—with the pre-trained generative model. In some examples, the entire activation volume may be captured for each prompt, although in other cases, a subset can be stored, the subset predetermined based on the model definition.

At circle (2), the model unlearning training service 120 captures the activation volume maps 525 associated with each of the prompts in the training data. Each map is associated with a prompt in the training data 125, thus each map represents either a positive or negative prompt. The process of evaluating prompts and capturing activation volume maps can be performed by one or more compute instances (not shown).

At circle (3), a statistical profiling engine 530 identifies which neurons contain a high amount of information for the negative case (the concept is present) and, optionally, for the positive case (the concept is not present) by comparing the neuron activation map distributions of positive samples with those of negative samples. For example, the statistical profiling engine 530 can identify a pattern of neuron activations and, optionally, levels that satisfy one or more detection requirements (e.g., false negative rate below some threshold, false positive rate below some threshold, true positive rate above some threshold, and/or true negative rate above some threshold). Various statistical techniques can be used to identify the pattern. In some examples, dimensionality reduction techniques such as principal component analysis can be used to reduce the complexity of the analysis. For example, the activation distribution for samples could be reduced to a lower-dimension indicative of the neurons that principally contribute to the appearance of a concept to be forgotten in the negative samples over those that fire from positive samples (e.g., from an activation volume with 10,000 activations to N activations).

Once the set of neuron activations associated with the concept to be forgotten are identified, the set of conditions 535 indicative of the pattern can be formalized for evaluation by the detector during subsequent passes of an adapted pre-trained generative model (e.g., by detector 227 of model 121A). An example set of conditions could include tests that evaluate true or false, where all of the conditions need to be satisfied in order to infer a detection (e.g., neuron activation A is below 0.0, neuron activation B is above 12, neuron activation C is between 2 and 4, etc.). In some examples, activation values can be normalized to ‘0’ or ‘1’ and evaluated against a mask using an exclusive OR operation, the mask having associated ‘0’s for neurons that are indicative of the concept when inactive and ‘1’s for neurons that are indicative of the concept when active. In some examples, the detector could be calibrated with the statistical profile of a set of neurons for the concept to be forgotten such that when subsequent forward passes result in a data point within that profile, the detector can cause the use of the different parameters.

In some examples, the search space for the statistical profiling engine 530 can be constrained with the benefit of gradient-based approaches. For example, during the processing of the prompts in the training data 125, model outputs 575 can be stored. The model outputs can be evaluated by an objective identification model 580 that can identify and locate, via bounding box, concepts such as the concept to be forgotten. Based on the presence and location of the concept in the output, a gradient-weighted class activation mapping or GradCAM engine 585 can calculate the gradients backward through the model to find regions of the activation volume most sensitive to a concept. The GradCAM engine 585 can provide an identification of the activation volume region(s) to the statistical profiling engine 530, which in turn can exclude unidentified regions from its profiling.

FIG. 6 is a diagram illustrating exemplary model parameter update strategies according to some examples. A simple neuron structure of a neural network is illustrated in each of FIGS. 6A-6C. The neuron includes inputs from various upstream activations scaled by weights W and summed, adjusted by a bias, B, and then fed into another activation function. In this example, the topmost input to the sum is scaled by weight W1, the middle input is scaled by the weight W2, and the bottom input (indicated as coming from a neuron signaling the presence of a concept) is scaled by weight W3, where weights W1, W2, and W3 are the pre-trained weights associated with the generative model. Since neuron activations used to identify the pattern associated with a concept are strongly correlated with that concept, one approach to update the weights is to update the weights applied to those activations associated with the detection (here, the bottom input). For example, if an activation from neuron X of layer Y triggers a detection, the inputs to neurons in layer Y+1 from neuron X can be adjusted via changes to the corresponding weights.

FIG. 6A illustrates zeroing out the activations associated with the concept by setting the update weights to equal magnitude and opposite sign of the pre-trained model weights. In this manner, the zeroed weight prevents the propagation of the activations associated with the concept. FIG. 6B illustrates “fuzzing” the activations associated with the concept by adding noise (e.g., a random value bounded by +/−X). In this manner, the randomized noise serves to steer the model toward another outcome (and away from the pattern that trigger the detector). FIG. 6C illustrates adjusting the weights according to a mapping function that steers the activations toward those profiled in an unrelated concept (e.g., a cat instead of a dog). In such a case, the pattern of a permitted concept can be developed by the statistical profiling engine 530. A mapping function can adjust the weight such that the input value scaled by the weight results in an input to the neuron that matches an input of the permitted concept. This mapping function can be predetermined during statistical profiling of the negative and positive samples. For example, if a detected input is −0.8 and a permitted concept is 0.7, the mapping function can return a weight for the neuron of −0.875 (e.g., the input −0.8 multiplied by −0.875 yields 0.7). Regardless of the selected strategy, the model unlearning training service 120 can store the weight updates as weight updates 229 for use by the adapter. The illustrated examples contemplate updating the existing weight W3. As indicated elsewhere herein, other embodiments may reroute the dataflow through the model such that the existing weights remain unmodified.

Note that in generating the weight updates 229, the model unlearning training service 120 can scale the weight updates by the user-specified degree to which the concept is forgotten (e.g., via GUI element 345). For example, if the scaling factor is 0.5, the weight update under FIG. 6A would be −0.5*W3.

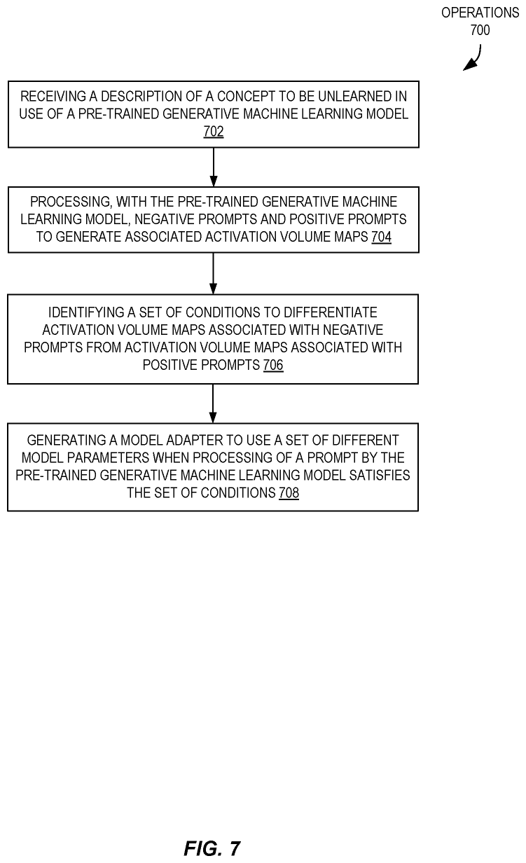

FIG. 7 is a flow diagram illustrating operations 700 of a method for generating a pre-trained generative model adapter according to some examples. Some or all of the operations 700 (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 700 are performed by machine learning services 110 such as the model unlearning training service 120 of the other figures.

The operations 700 include, at block 702, receiving a description of a concept to be unlearned in use of a pre-trained generative machine learning model. The description can be provided subject to the input modality of the model being untrained. For example, a text description can be provided for text-to-text models or text-to-image models, an image for image to image models or image to text models, etc.

The operations 700 further include, at block 704, processing, with the pre-trained generative machine learning model, negative prompts and positive prompts to generate associated activation volume maps. As described herein, activation volumes represent intermediate values of the model during processing of a prompt. These intermediate values from these prompt processing forward passes are stored as maps (e.g., prompt A has a corresponding map A, prompt B has a corresponding map B, and so on).

The operations 700 further include, at block 706, identifying a set of conditions to differentiate activation volume maps associated with negative prompts from activation volume maps associated with positive prompts. As described herein, the set of conditions may be a set of outputs or activations to monitor and associated activation levels (e.g., above or below thresholds). The set of conditions can be identified using statistical techniques to identify the pattern of signature of the negative samples that can be distinguished (to a certain confidence) from positive samples.

The operations 700 further include, at block 708, generating a model adapter to use a set of different model parameters when processing of a prompt by the pre-trained generative machine learning model satisfies the set of conditions. As described herein, various techniques can be used to adapt a pre-trained generative machine learning model. A model definition update can be generated to modify one or more portions of the model definition with a detector, such as conditional statements in software, and different weights can be used based on the detection of a pattern. Some examples may temporarily update the pre-trained weights in place to perturb the output. Other examples may reroute the dataflow through the model to apply the different weights.

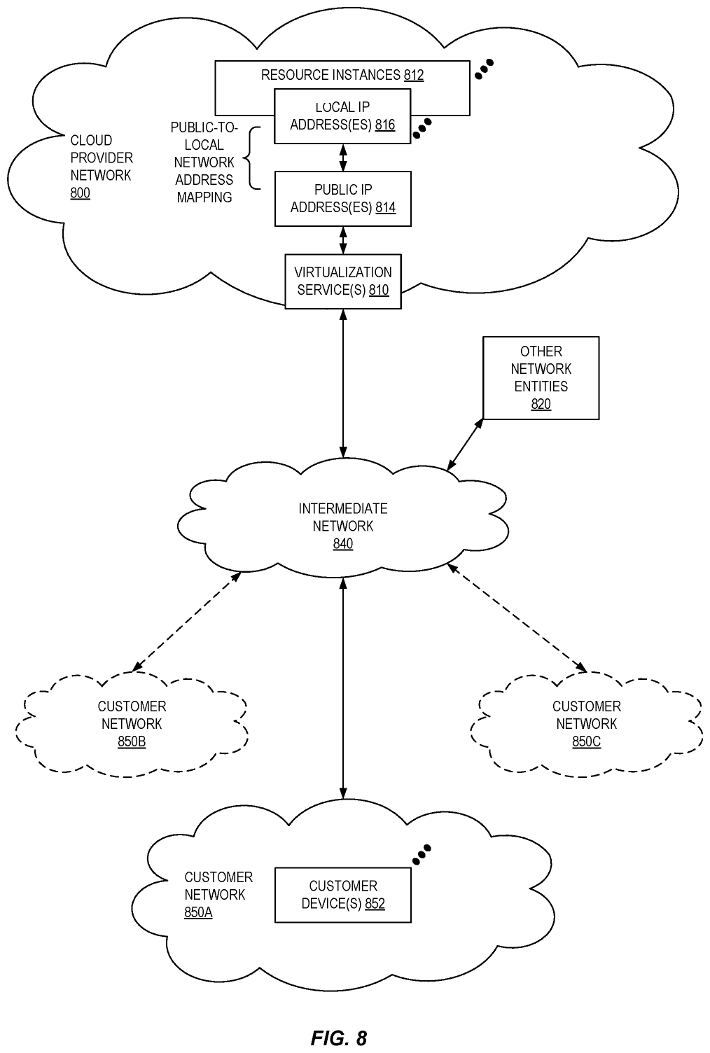

FIG. 8 illustrates an example provider network (or “service provider system”) environment according to some examples. A provider network 800 can provide resource virtualization to customers via one or more virtualization services 810 that allow customers to purchase, rent, or otherwise obtain instances 812 of virtualized resources, including but not limited to computation and storage resources, implemented on devices within the provider network or networks in one or more data centers. Local Internet Protocol (IP) addresses 816 can be associated with the resource instances 812; the local IP addresses are the internal network addresses of the resource instances 812 on the provider network 800. In some examples, the provider network 800 can also provide public IP addresses 814 and/or public IP address ranges (e.g., Internet Protocol version 4 (IPv4) or Internet Protocol version 6 (IPv6) addresses) that customers can obtain from the provider 800.

Conventionally, the provider network 800, via the virtualization services 810, can allow a customer of the service provider (e.g., a customer that operates one or more customer networks 850A-850C (or “client networks”) including one or more customer device(s) 852) to dynamically associate at least some public IP addresses 814 assigned or allocated to the customer with particular resource instances 812 assigned to the customer. The provider network 800 can also allow the customer to remap a public IP address 814, previously mapped to one virtualized computing resource instance 812 allocated to the customer, to another virtualized computing resource instance 812 that is also allocated to the customer. Using the virtualized computing resource instances 812 and public IP addresses 814 provided by the service provider, a customer of the service provider such as the operator of the customer network(s) 850A-850C can, for example, implement customer-specific applications and present the customer's applications on an intermediate network 840, such as the Internet. Other network entities 820 on the intermediate network 840 can then generate traffic to a destination public IP address 814 published by the customer network(s) 850A-850C; the traffic is routed to the service provider data center, and at the data center is routed, via a network substrate, to the local IP address 816 of the virtualized computing resource instance 812 currently mapped to the destination public IP address 814. Similarly, response traffic from the virtualized computing resource instance 812 can be routed via the network substrate back onto the intermediate network 840 to the source entity 820.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 800; a customer can then assign their allocated public IP addresses to particular resource instances allocated to the customer. These public IP addresses can be referred to as customer public IP addresses, or simply customer IP addresses. Instead of being assigned by the provider network 800 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

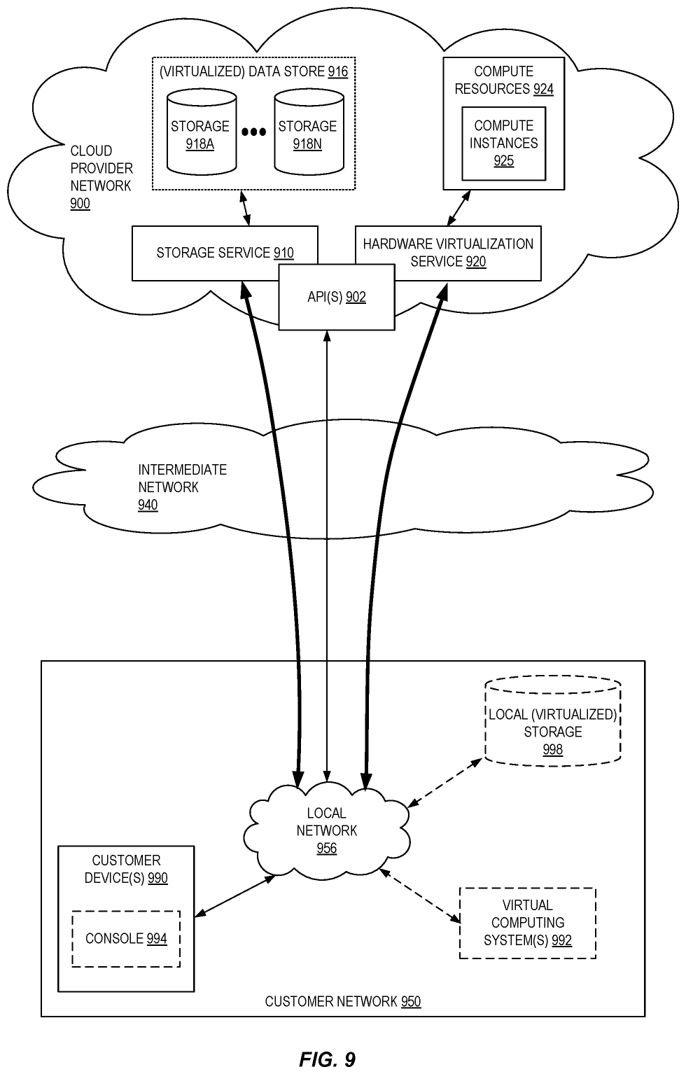

FIG. 9 is a block diagram of an example provider network environment that provides a storage service and a hardware virtualization service to customers, according to some examples. A hardware virtualization service 920 provides multiple compute resources 924 (e.g., compute instances 925, such as VMs) to customers. The compute resources 924 can, for example, be provided as a service to customers of a provider network 900 (e.g., to a customer that implements a customer network 950). Each computation resource 924 can be provided with one or more local IP addresses. The provider network 900 can be configured to route packets from the local IP addresses of the compute resources 924 to public Internet destinations, and from public Internet sources to the local IP addresses of the compute resources 924.

The provider network 900 can provide the customer network 950, for example coupled to an intermediate network 940 via a local network 956, the ability to implement virtual computing systems 992 via the hardware virtualization service 920 coupled to the intermediate network 940 and to the provider network 900. In some examples, the hardware virtualization service 920 can provide one or more APIs 902, for example a web services interface, via which the customer network 950 can access functionality provided by the hardware virtualization service 920, for example via a console 994 (e.g., a web-based application, standalone application, mobile application, etc.) of a customer device 990. In some examples, at the provider network 900, each virtual computing system 992 at the customer network 950 can correspond to a computation resource 924 that is leased, rented, or otherwise provided to the customer network 950.

From an instance of the virtual computing system(s) 992 and/or another customer device 990 (e.g., via console 994), the customer can access the functionality of a storage service 910, for example via the one or more APIs 902, to access data from and store data to storage resources 918A-918N of a virtual data store 916 (e.g., a folder or “bucket,” a virtualized volume, a database, etc.) provided by the provider network 900. In some examples, a virtualized data store gateway (not shown) can be provided at the customer network 950 that can locally cache at least some data, for example frequently accessed or critical data, and that can communicate with the storage service 910 via one or more communications channels to upload new or modified data from a local cache so that the primary store of data (the virtualized data store 916) is maintained. In some examples, a user, via the virtual computing system 992 and/or another customer device 990, can mount and access virtual data store 916 volumes via the storage service 910 acting as a storage virtualization service, and these volumes can appear to the user as local (virtualized) storage 998.

While not shown in FIG. 9, the virtualization service(s) can also be accessed from resource instances within the provider network 900 via the API(s) 902. For example, a customer, appliance service provider, or other entity can access a virtualization service from within a respective virtual network on the provider network 900 via the API(s) 902 to request allocation of one or more resource instances within the virtual network or within another virtual network.

### Illustrative Systems

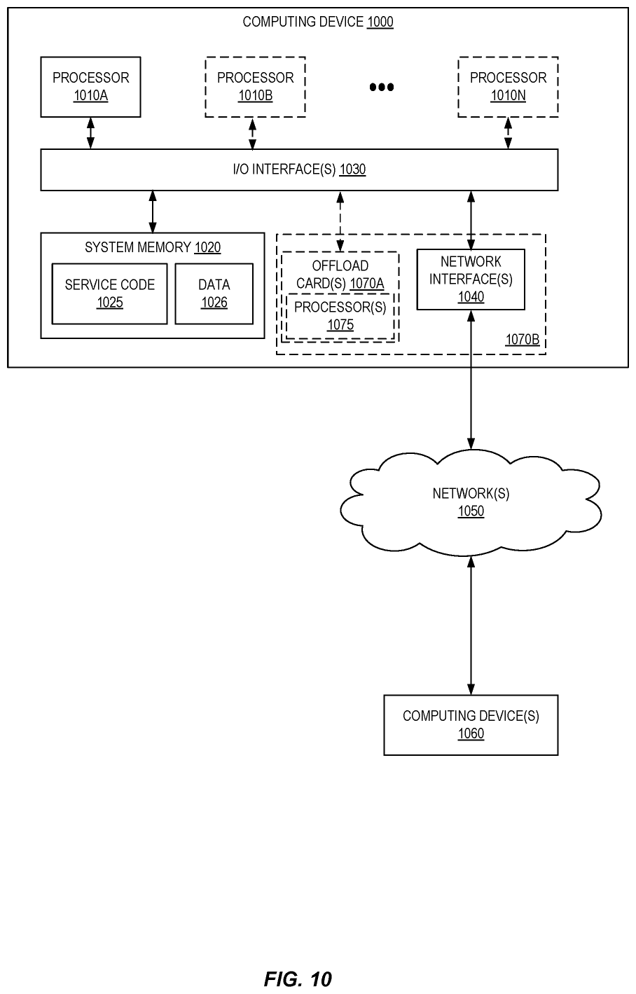

In some examples, a system that implements a portion or all of the techniques described herein can include a general-purpose computer system, such as the computing device 1000 (also referred to as a computing system or electronic device) illustrated in FIG. 10, that includes, or is configured to access, one or more computer-accessible media. In the illustrated example, the computing device 1000 includes one or more processors 1010 coupled to a system memory 1020 via an input/output (I/O) interface 1030. The computing device 1000 further includes a network interface 1040 coupled to the I/O interface 1030. While FIG. 10 shows the computing device 1000 as a single computing device, in various examples the computing device 1000 can include one computing device or any number of computing devices configured to work together as a single computing device 1000.

In various examples, the computing device 1000 can be a uniprocessor system including one processor 1010, or a multiprocessor system including several processors 1010 (e.g., two, four, eight, or another suitable number). The processor(s) 1010 can be any suitable processor(s) capable of executing instructions. For example, in various examples, the processor(s) 1010 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 1010 can commonly, but not necessarily, implement the same ISA.

The system memory 1020 can store instructions and data accessible by the processor(s) 1010. In various examples, the system memory 1020 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 1020 as model unlearning training service code 1025 (e.g., executable to implement, in whole or in part, the model unlearning training service 120) and data 1026.

In some examples, the I/O interface 1030 can be configured to coordinate I/O traffic between the processor 1010, the system memory 1020, and any peripheral devices in the device, including the network interface 1040 and/or other peripheral interfaces (not shown). In some examples, the I/O interface 1030 can perform any necessary protocol, timing, or other data transformations to convert data signals from one component (e.g., the system memory 1020) into a format suitable for use by another component (e.g., the processor 1010). In some examples, the I/O interface 1030 can include support for devices attached through various types of peripheral buses, such as a variant of the Peripheral Component Interconnect (PCI) bus standard or the Universal Serial Bus (USB) standard, for example. In some examples, the function of the I/O interface 1030 can be split into two or more separate components, such as a north bridge and a south bridge, for example. Also, in some examples, some or all of the functionality of the I/O interface 1030, such as an interface to the system memory 1020, can be incorporated directly into the processor 1010.

The network interface 1040 can be configured to allow data to be exchanged between the computing device 1000 and other computing devices 1060 attached to a network or networks 1050, such as other computer systems or devices as illustrated in FIG. 1, for example. In various examples, the network interface 1040 can support communication via any suitable wired or wireless general data networks, such as types of Ethernet network, for example. Additionally, the network interface 1040 can support communication via telecommunications/telephony networks, such as analog voice networks or digital fiber communications networks, via storage area networks (SANs), such as Fibre Channel SANs, and/or via any other suitable type of network and/or protocol.

In some examples, the computing device 1000 includes one or more offload cards 1070A or 1070B (including one or more processors 1075, and possibly including the one or more network interfaces 1040) that are connected using the I/O interface 1030 (e.g., a bus implementing a version of the Peripheral Component Interconnect-Express (PCI-E) standard, or another interconnect such as a QuickPath interconnect (QPI) or UltraPath interconnect (UPI)). For example, in some examples the computing device 1000 can act as a host electronic device (e.g., operating as part of a hardware virtualization service) that hosts compute resources such as compute instances, and the one or more offload cards 1070A or 1070B execute a virtualization manager that can manage compute instances that execute on the host electronic device. As an example, in some examples the offload card(s) 1070A or 1070B can perform compute instance management operations, such as pausing and/or un-pausing compute instances, launching and/or terminating compute instances, performing memory transfer/copying operations, etc. These management operations can, in some examples, be performed by the offload card(s) 1070A or 1070B in coordination with a hypervisor (e.g., upon a request from a hypervisor) that is executed by the other processors 1010A-1010N of the computing device 1000. However, in some examples the virtualization manager implemented by the offload card(s) 1070A or 1070B can accommodate requests from other entities (e.g., from compute instances themselves), and cannot coordinate with (or service) any separate hypervisor.

In some examples, the system memory 1020 can be one example of a computer-accessible medium configured to store program instructions and data as described above. However, in other examples, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computing device 1000 via the I/O interface 1030. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing device 1000 as the system memory 1020 or another type of memory. Further, a computer-accessible medium can include transmission media or signals such as electrical, electromagnetic, or digital signals, conveyed via a communication medium such as a network and/or a wireless link, such as can be implemented via the network interface 1040.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely-available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle (R), Microsoft (R), Sybase (R), IBM (R), etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 918A-918N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases do not necessarily refer to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
receiving, by a machine learning service of a cloud provider network, a request to unlearn a concept from a pre-trained generative machine learning model, the request including an identification of the pre-trained generative machine learning model and a description of the concept;
generating, using a language model, a set of negative prompts and a set of positive prompts, the negative prompts including the concept, the positive prompts not including concept;
processing, with the pre-trained generative machine learning model, negative prompts and positive prompts to generate associated activation volume maps, wherein an activation volume map for a given prompt includes outputs from one or more layers of the pre-trained generative model;
identifying a set of activation conditions to differentiate activation volume maps associated with negative prompts from activation volume maps associated with positive prompts;
generating a model adapter to use a set of different model parameters when processing of a prompt by the pre-trained generative machine learning model satisfies the set of activation conditions.

2. The computer-implemented method of claim 1, further comprising:
executing the pre-trained generative machine learning model and the model adapter by a compute resource of the cloud provider network;
receiving a user-submitted prompt; and
processing the user-submitted prompt with the pre-trained generative machine learning model, wherein the processing includes:
determining, with the model adapter, that the processing of the user-submitted prompt satisfies the set of activation conditions; and
using the set of different model parameters to process the user-submitted prompt.

3. The computer-implemented method of claim 1, wherein the set of different model parameters are based on at least one of zeroing out a corresponding set of pre-trained model weights, adding random noise to the corresponding set of pre-trained model weights, or adding a set of predetermined weights to the corresponding set of pre-trained model weights to bias the pre-trained generative machine learning model from the concept to another concept.

4. A computer-implemented method comprising:
receiving a description of a concept to be unlearned in use of a pre-trained generative machine learning model;
processing, with the pre-trained generative machine learning model, negative prompts and positive prompts to generate associated activation volume maps;
identifying a set of conditions to differentiate activation volume maps associated with negative prompts from activation volume maps associated with positive prompts; and
generating a model adapter to use a set of different model parameters when processing of a prompt by the pre-trained generative machine learning model satisfies the set of conditions.

5. The computer-implemented method of claim 4, further comprising:
executing the pre-trained generative machine learning model with the model adapter;
receiving a user-submitted prompt; and
processing the user-submitted prompt with the pre-trained generative machine learning model, wherein the processing includes:
determining, with the model adapter, that the processing of the user-submitted prompt satisfies the set of conditions; and
using the set of different model parameters to process the user-submitted prompt.

6. The computer-implemented method of claim 5, wherein using the set of different model parameters to process the user-submitted prompt includes at least one of updating pre-trained model parameters with a set of update parameters or redirecting an output from a layer of the pre-trained generative machine learning model through a different layer including the set of different model parameters.

7. The computer-implemented method of claim 4, wherein the set of different model parameters are based on at least one of zeroing out a corresponding set of pre-trained model weights of the pre-trained generative machine learning model, adding random noise to the corresponding set of pre-trained model weights, or adding a set of predetermined weights to the corresponding set of pre-trained model weights to bias the pre-trained generative machine learning model from the concept to another concept.

8. The computer-implemented method of claim 4, further comprising receiving an indication of a degree to which to unlearn the concept, wherein at least a portion of the set of different model parameters are based on the degree to which to unlearn the concept.

9. The computer-implemented method of claim 4, further comprising identifying, using a gradient-based activation mapping, a first region of a model activation volume sensitive to a first negative prompt and a second region of the model activation volume sensitive to a first positive negative prompt, and wherein the set of conditions are localized to activations within the first and second regions of the model activation volume.

10. The computer-implemented method of claim 4, further comprising generating, using a language model, at least some of the negative prompts and at least some of the positive prompts, the negative prompts including the concept, the positive prompts not including concept.

11. The computer-implemented method of claim 10, further comprising:
receiving, from the language model, an indication of a related concept and an indication of a correlation between the concept to be unlearned and the related concept;
determining that the indication of the correlation satisfies a threshold;
generating, with the pre-trained generative machine learning model, an output based on a prompt that includes the related concept;
receiving a user-submitted classification of the output as a positive sample; and
classifying the prompt that includes the related concept as a positive prompt.

12. The computer-implemented method of claim 4 performed by a machine learning service of a cloud provider network.

13. The computer-implemented method of claim 4, wherein the description of the concept to be unlearned was received from an electronic device and further comprising:
sending the model adapter to the electronic device, whereby the model adapter can be deployed with the pre-trained generative machine learning model to reduce a likelihood of the concept to be unlearned from appearing in an output of the pre-trained generative machine learning model.

14. A system comprising:
a first one or more computing devices to execute a pre-trained generative machine learning model in a multi-tenant provider network; and
a second one or more computing devices to implement a model unlearning training service in the multi-tenant provider network, the model unlearning training service including instructions that upon execution cause the model unlearning training service to:
receive a description of a concept to be unlearned in use of the pre-trained generative machine learning model;
process, with the pre-trained generative machine learning model, negative prompts and positive prompts to generate associated activation volume maps;
identify a set of conditions to differentiate activation volume maps associated with negative prompts from activation volume maps associated with positive prompts; and
generate a model adapter to use a set of different model parameters when processing of a prompt by the pre-trained generative machine learning model satisfies the set of conditions.

15. The system of claim 14, further comprising:
a third one or more computing devices to execute the pre-trained generative machine learning model with the model adapter in the multi-tenant provider network, wherein an environment to execute the pre-trained generative machine learning model with the model adapter includes instructions to:
receive a user-submitted prompt; and
process the user-submitted prompt with the pre-trained generative machine learning model, wherein the instructions to process include instructions to:
determine, with the model adapter, that the processing of the user-submitted prompt satisfies the set of conditions; and
use the set of different model parameters to process the user-submitted prompt.

16. The system of claim 15, wherein the instructions to use the set of different model parameters to process the user-submitted prompt include at least one of instructions to update pre-trained model parameters with a set of update parameters or instructions to redirect an output from a layer of the pre-trained generative machine learning model through a different layer including the set of different model parameters.

17. The system of claim 14, wherein the set of different model parameters are based on at least one of zeroing out a corresponding set of pre-trained model weights of the pre-trained generative machine learning model, adding random noise to the corresponding set of pre-trained model weights, or adding a set of predetermined weights to the corresponding set of pre-trained model weights to bias the pre-trained generative machine learning model from the concept to another concept.

18. The system of claim 14, wherein the model unlearning training service includes further instructions that upon execution cause the model unlearning training service to receive an indication of a degree to which to unlearn the concept, wherein at least a portion of the set of different model parameters are based on the degree to which to unlearn the concept.

19. The system of claim 14, wherein the model unlearning training service includes further instructions that upon execution cause the model unlearning training service to identify, using a gradient-based activation mapping, a first region of a model activation volume sensitive to a first negative prompt and a second region of the model activation volume sensitive to a first positive negative prompt, and wherein the set of conditions are localized to activations within the first and second regions of the model activation volume.

20. The system of claim 14, wherein the model unlearning training service includes further instructions that upon execution cause the model unlearning training service to generate, using a language model, at least some of the negative prompts and at least some of the positive prompts, the negative prompts including the concept, the positive prompts not including concept.
